(19) United States
(12) Patent Application Publication
(10) Pub. No.: US 2024/0283192 A1
(43) Pub. Date: Aug. 22, 2024

(54) CONNECTOR

(71) Applicant: YAZAKI CORPORATION, Tokyo (JP)

(72) Inventors: Seiji Kozono, Kakegawa-shi (JP); Yoshitaka Tsushima, Kakegawa-shi (JP)

(21) Appl. No.: 18/653,976

(22) Filed: May 3, 2024

Related U.S. Application Data
(63) Continuation of application No. PCT/JP2023/004862, filed on Feb. 13, 2023.

(30) Foreign Application Priority Data
Feb. 21, 2022 (JP) 2022-025077

(51) Int. Cl. H01R 13/52

(52) U.S. Cl. CPC H01R 13/5202; H01R 13/5213

(57) ABSTRACT

A cover covers a front opening of a tubular portion of a housing in an openable and closable manner. An annular packing is attached to the cover, and seals a gap between the tubular portion and the cover at a closed position where the cover closes the front opening. The outer surface of the packing includes a first lip portion that covers an end surface of the tubular portion from a front side and a second lip portion provided behind the first lip portion and press-fitted between the cover and an inner surface of the tubular portion at the closed position.

### CROSS-REFERENCE TO RELATED APPLICATIONS

This is a continuation of International Application No. PCT/JP2023/004862 filed on Feb. 13, 2023, and claims priority from Japanese Patent Application No. 2022-025077 filed on Feb. 21, 2022, the entire content of which is incorporated herein by reference.

### TECHNICAL FIELD

The present invention relates to a connector including a cover.

### BACKGROUND ART

In related art, wire harnesses (electric wires) that electrically connect various electric components mounted on an automobile or the like are connected by connectors. Such a connector generally includes a male connector and a female connector. For example, in a case of a connector structure applied to an optional specification, there is known a connector structure in which one connector connected to an end portion of an electric wire arranged in advance has a shutter mechanism at a front opening of a housing for a purpose of dust proofing, terminal protection, prevention of electric shock to the surroundings, and the like until the other connector is fitted thereto. Particularly in an electric automobile or the like, in order to prevent an electric shock accident or the like, a connector (inlet) with a shutter mechanism is applied to prevent exposure of a terminal at a front opening when the connector is not fitted. As an example of such a configuration, for example, there is a connector with a shutter mechanism disclosed in Patent Literature 1.

However, the connector with the shutter mechanism according to Patent Literature 1 has a structure in which a front opening of a housing is merely covered with a shutter. Therefore, there is a gap between the shutter and the connector, and dust, water, or the like may enter the connector.

When the shutter is closed, it is conceivable to press-fit a packing into the gap between the shutter and the connector. An annular packing disclosed in Patent Literature 2 is known as the packing. In order to improve waterproofness and dustproof property, it is conceivable to increase a press-fitting force by increasing an amount of collapse of the packing when the packing is inserted into the gap. However, there is a problem in that increasing the press-fitting force increases a force applied when closing the shutter.

### CITATION LIST

### Patent Literature

Patent Literature 1: JPH08-138785A
Patent Literature 2: JP2020-048263A

### SUMMARY OF INVENTION

### Technical Problem

The present invention has been made in view of the above circumstances, and an object thereof is to provide a connector that improves waterproofness and dustproof property while reducing a force applied when closing a cover.

### Solution to Problem

In order to achieve the above object, a connector according to the present invention has the following features.

A connector includes:
a housing including an accommodating portion that accommodates a connection terminal and a tubular portion having an opening into which a mating connector is to be inserted;
a cover configured to cover the opening in an openable and closable manner; and
an annular packing configured to be attached to the cover and to seal a gap between the tubular portion and the cover at a closed position where the cover closes the opening, in which
an outer surface of the packing includes a first lip portion that covers an end surface of the tubular portion from a side in a direction opposite to an insertion direction of the mating connector, and a second lip portion provided on an insertion direction side of the first lip portion and press-fitted between the cover and an inner surface of the tubular portion, at the closed position.

### Advantageous Effects of Invention

According to the present invention, it is possible to provide a connector that improves waterproofness and dustproof property while reducing a force applied when closing a cover.

The present invention has been briefly described above. Further, details of the present invention can be clarified by reading modes (hereinafter, referred to as “embodiments”) for carrying out the invention to be described below with reference to the accompanying drawings.

### BRIEF DESCRIPTION OF DRAWINGS

FIG. 1 is a perspective view showing an embodiment of an inlet as a connector according to the present invention.

FIG. 2 is an exploded perspective view of the inlet shown in FIG. 1.

FIG. 3 is a partial cross-sectional exploded perspective view of a cover constituting the inlet shown in FIG. 1.

FIG. 4 is a partial cross-sectional view of the cover constituting the inlet shown in FIG. 1 when the cover is at a closed position.

FIG. 5 is a partial cross-sectional view of the inlet when the cover is at an open position.

FIG. 6 is a partial cross-sectional view of the inlet when the cover is at the closed position.

FIG. 7 is a partial enlarged view of FIG. 6.

### DESCRIPTION OF EMBODIMENTS

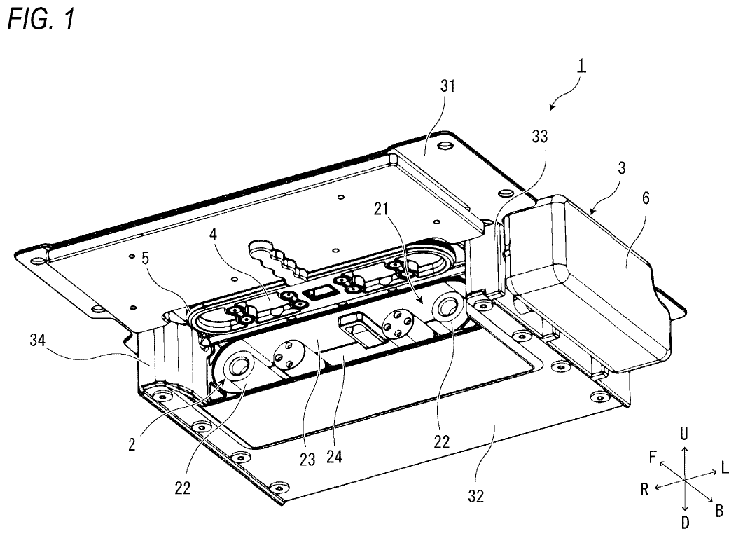

Specific embodiments of the present invention will be described below with reference to the drawings. Hereinafter, as shown in FIG. 1 and the like, a “front-back direction (FB direction)”, a “left-right direction (RL direction)”, an “up-down direction (UD direction)”, “front (F)”, “back (B)”, “left (L)”, “right (R)”, “up (U)”, and “down (D)” are defined for convenience of description. The “front-back direction”, the “left-right direction”, and the “up-down direction” are orthogonal to one another.

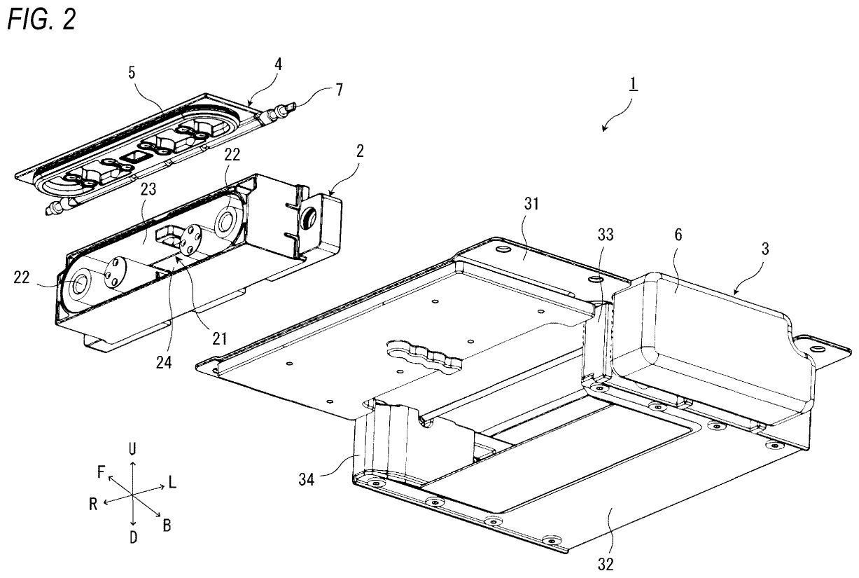

An inlet plug (not shown), which is a mating connector, is fitted into an inlet 1, which is a connector according to the present embodiment. As shown in FIGS. 1 and 2, the inlet 1 includes a housing 2 that accommodates connection terminals, an outer case 3 that accommodates and holds the housing 2, a cover 4 that covers a front opening 21 of the housing 2 in an openable and closable manner, and an annular packing 5 that seals a gap between the cover 4 and the housing 2.

The housing 2 of the inlet 1 is molded from an electrically insulating synthetic resin. The housing 2 includes a pair of accommodating portions 22, 22 that respectively accommodate the connection terminals connected to end portions of high-voltage cables (not shown), and a tubular portion 23 having the front opening 21 into which the inlet plug is to be inserted.

In the present specification, a rearward direction is an insertion direction in which the inlet plug is inserted, and a forward direction is a direction opposite to the insertion direction.

The pair of accommodating portions 22, 22 protrude forward from a front wall portion 24 orthogonal to (intersecting) the front-back direction. The front wall portion 24 is elongated in the left-right direction, and the pair of accommodating portions 22, 22 are arranged side by side in the left-right direction. The tubular portion 23 protrudes forward from the front wall portion 24. The tubular portion 23 has an oval shape elongated in the left-right direction when viewed from a front side, and continuously surrounds the pair of accommodating portions 22, 22 without interruption. The tubular portion 23 has the front opening 21 into which the inlet plug is to be inserted.

The outer case 3 is a flat housing including a top plate 31 that covers an upper side of the housing 2, a bottom plate 32 that covers a lower side of the housing 2, a left side portion 33 that covers a left side surface of the housing 2, and a right side portion 34 that covers a right side surface of the housing 2, with both sides in the front-back direction open. The left side portion 33 and the right side portion 34 rotatably support both ends of a rotating shaft 7 of the cover 4. A motor 6 is attached to the left side portion 33. The motor 6 rotates the cover 4 by applying a driving force to the rotating shaft 7.

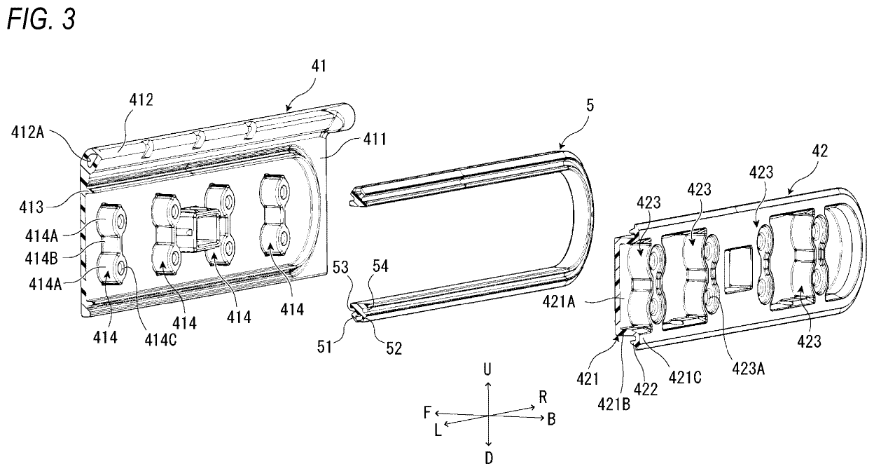

The cover 4 is made of an electrically insulating synthetic resin. As shown in FIG. 3, the cover 4 includes a front cover 41 as a first member and a rear cover 42 as a second member. The front cover 41 is disposed in front of the rear cover 42 at a closed position where the front opening 21 is closed. The rear cover 42 is disposed behind the front cover 41 at the closed position. The front cover 41 and the rear cover 42 are separately provided to sandwich and hold the packing 5 therebetween.

The front cover 41 includes a front cover body 411 that covers the front opening 21, a rotating shaft portion 412, a first protrusion 413 annularly protruding from the front cover body 411, and first fixing portions 414 for fixing the rear cover 42 to be described later. The front cover body 411 has a substantially rectangular plate shape elongated in the left-right direction. The rotating shaft portion 412 is provided at an upper end of the front cover body 411 at the closed position, and is provided along the left-right direction.

In the present embodiment, the rotating shaft portion 412 has a tubular shape, and has, therein, an insertion hole 412A into which the metal rotating shaft 7 (see FIG. 2) is to be inserted. As shown in FIG. 2, the rotating shaft 7 protrudes from both left and right ends of the rotating shaft portion 412, and both ends thereof are rotatably supported by the outer case 3. The metal rotating shaft 7 inserted into the rotating shaft portion 412 of the front cover 41 is rotatably supported by the outer case 3 in the present embodiment, but present invention is not limited thereto. The rotating shaft portion 412 of the front cover 41 may be rotatably supported by the outer case 3.

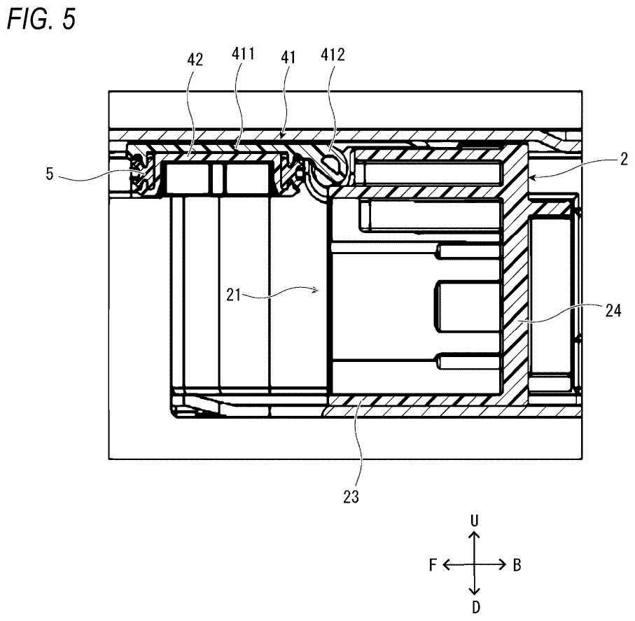

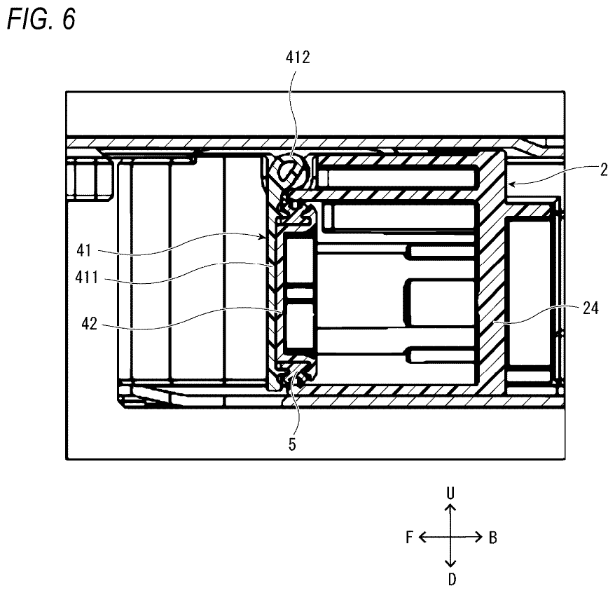

The cover 4 rotates about the rotating shaft portion 412 between an open position (FIG. 5) and the closed position (FIG. 6). The open position is a position where the front cover body 411 is perpendicular to the up-down direction and the front opening 21 is open. The closed position is a position where the front cover body 411 is perpendicular to the front-back direction and the front opening 21 is closed.

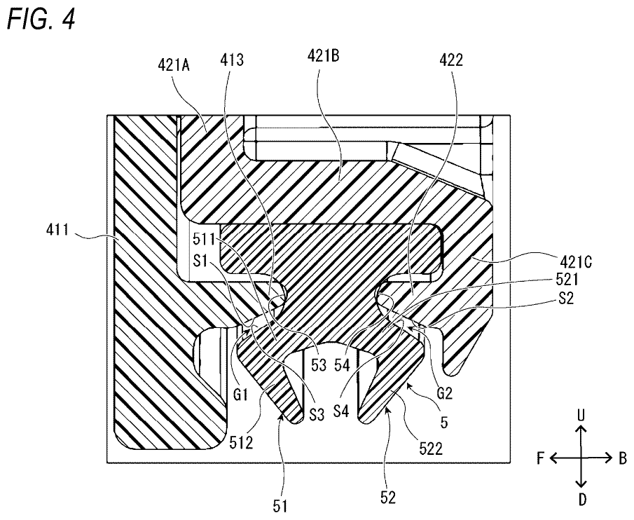

As shown in FIGS. 3 and 4, the first protrusion 413 has a substantially oval annular shape elongated in the left-right direction along the inside of the tubular portion 23. The first protrusion 413 protrudes rearward from the front cover body 411 at the closed position. As shown in FIG. 3, the first fixing portions 414 protrude from a portion of the front cover body 411 surrounded by the first protrusion 413.

In the present embodiment, four first fixing portions 414 are arranged side by side in the left-right direction. Each of the first fixing portions 414 includes a pair of bosses 414A, 414A and a rib 414B connecting the pair of bosses 414A, 414A. The pair of bosses 414A, 414A are arranged side by side in the up-down direction, and each have a screw hole 414C that is screwed with a screw. The rib 414B connects an upper end and a lower end of the pair of bosses 414A, 414A arranged side by side in the up-down direction, and is elongated in the up-down direction.

The rear cover 42 includes a rear cover body 421, a second protrusion 422 annularly protruding from the rear cover body 421, and second fixing portions 423 for fixing the front cover 41. The rear cover body 421 includes a wall portion 421A facing, in the front-back direction, the portion of the front cover body 411 surrounded by the first protrusion 413, a side wall portion 421B standing rearward from an edge portion of the wall portion 421A, and a flange portion 421C protruding outward from a rear end of the side wall portion 421B.

The wall portion 421A has an oval shape slightly smaller than the portion of the front cover body 411 surrounded by the first protrusion 413. The side wall portion 421B stands from the entire peripheral edge of the wall portion 421A and has an annular shape. As shown in FIG. 4, the side wall portion 421B is disposed inside the annular first protrusion 413 at an interval from the first protrusion 413, and the rear end of the side wall portion 421B protrudes further rearward than a tip end of the first protrusion 413. The flange portion 421C protrudes outward from the entire rear end of the side wall portion 421B and covers a rear side of the first protrusion 413. The second protrusion 422 protrudes forward from the flange portion 421C. The second protrusion 422 faces the first protrusion 413 at an interval in the front-back direction, and has a substantially oval annular shape.

As shown in FIG. 3, the second fixing portions 423 protrude rearward from the wall portion 421A. A recess into which the first fixing portion 414 is fitted is formed on a front side of the second fixing portion 423. The second fixing portion 423 has a screw through hole 423A through which a screw is to be inserted.

The packing 5 is made of an elastic member such as rubber. The packing 5 has an oval annular shape elongated in the left-right direction. The side wall portion 421B of the rear cover 42 is press-fitted into the packing 5. That is, as shown in FIG. 4, a flat inner surface of the packing 5 and an outer surface of the side wall portion 421B of the rear cover 42 overlap each other. An outer surface of the packing 5 serves as a contact surface that comes into contact with an inner surface of the tubular portion 23 at the closed position. In the present embodiment, the outer surface of the packing 5 includes a first lip portion 51 and a second lip portion 52 protruding side by side along a central axis direction of the packing 5. The first lip portion 51 and the second lip portion 52 are provided over the entire periphery of the packing 5. The first lip portion 51 and the second lip portion 52 will be described later.

In this specification, the central axis direction of the packing 5 is along the front-back direction at the closed position and along the up-down direction at the open position.

The packing 5 has a first recess 53 formed in a surface on one side in the central axis direction (front side in FIG. 3) and a second recess 54 formed in a surface on the other side in the central axis direction (rear side in FIG. 3). The first recess 53 and the second recess 54 are formed over the entire periphery of the packing 5. The first protrusion 413 of the front cover 41 is inserted into the first recess 53, and the second protrusion 422 of the rear cover 42 is inserted into the second recess 54. Accordingly, the packing 5 is sandwiched and held between the front cover 41 and the rear cover 42 in the central axis direction.

Next, detailed configurations of the first protrusion 413, the second protrusion 422, the first recess 53, and the second recess 54 will be described. As shown in FIG. 4, gaps G1, G2 are formed between the packing 5 and side surfaces S1, S2 of the first protrusion 413 and the second protrusion 422 closer to the first lip portion 51 and the second lip portion 52 than top portions of the first protrusion 413 and the second protrusion 422. In the present embodiment, the gaps G1, G2 are formed when the cover 4 is at both the open position and the closed position, but the gaps G1, G2 may be formed when the cover 4 is at least at the open position.

The side surfaces S1, S2 of the first protrusion 413 and the second protrusion 422 closer to the first lip portion 51 and the second lip portion 52 than the top portions of the first protrusion 413 and the second protrusion 422 are respectively provided on first inclined surfaces that are away from tip ends of the first lip portion 51 and the second lip portion 52 as approaching each other. Side surfaces S3, S4 (surfaces facing the side surfaces S1, S2) of the first recess 53 and the second recess 54 closer to the first lip portion 51 and the second lip portion 52 than bottom portions of the first recess 53 and the second recess 54 are respectively provided on second inclined surfaces that are away from the tip ends of the first lip portion 51 and the second lip portion 52 as approaching each other. Slopes of the second inclined surfaces provided with the side surfaces S3, S4 are larger than slopes of the first inclined surfaces provided with the side surfaces S1, S2. Therefore, when the cover 4 is at the open position, the gaps G1, G2 can be formed between the first inclined surfaces (side surfaces S1, S2) and the second inclined surfaces (side surfaces S3, S4).

Next, the first lip portion 51 and the second lip portion 52 will be described in detail. The first lip portion 51 and the second lip portion 52 protrude outward from the outer surface of the packing 5, and are arranged side by side along the central axis direction (front-back direction in FIG. 3). The first lip portion 51 and the second lip portion 52 include first inclined portions 511, 521 that are inclined along the second inclined surfaces of the side surfaces S3, S4, and second inclined portions 512, 522 that are continuous with tip end sides of the first inclined portions 511, 521 and approach each other toward the tip ends.

Next, assembly of the connector 1 will be described. First, the side wall portion 421B of the rear cover 42 is press-fitted into the inner surface of the packing 5 to attach the packing 5 to the rear cover 42. At this time, the second protrusion 422 is inserted into the second recess 54 of the packing 5. Next, the front cover 41 is stacked in front of the rear cover 42 attached with the packing 5. At this time, the first protrusion 413 of the front cover 41 is inserted into the first recess 53 of the packing 5. The first fixing portion 414 is fitted into the second fixing portion 423. Thereafter, a screw is inserted into the screw through hole 423A of the second fixing portion 423 and then screwed into the screw hole 414C of the first fixing portion 414. Accordingly, the cover 4 is completed. Thereafter, the housing 2 is accommodated in the outer case 3, and the cover 4 is attached to the outer case 3 to complete the process.

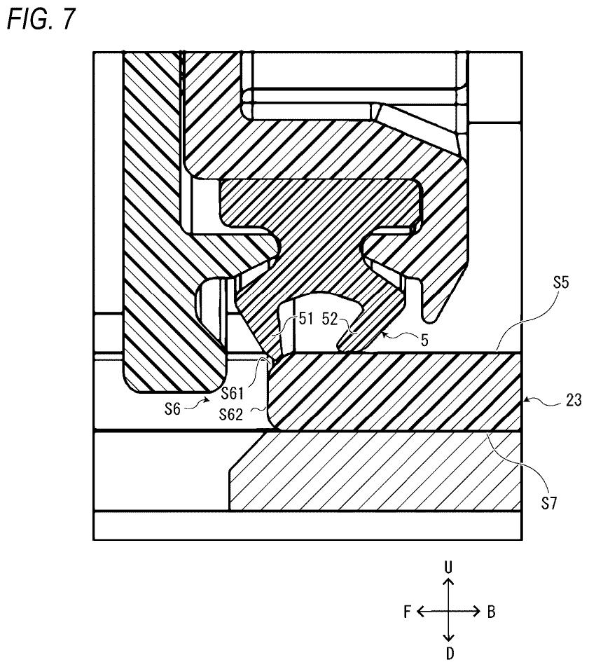

When the connector 1 is not to be fitted to the inlet plug, the motor 6 rotates the cover 4 from the open position (FIG. 5) to the closed position (FIG. 6). Accordingly, the front opening 21 is closed by the cover 4. Specifically, when rotating the cover 4 to the closed position, the second lip portion 52 first reaches an inner surface S5 (see FIG. 7) of the tubular portion 23, and the tip end of the second lip portion 52 moves rearward while being in sliding-contact with the inner surface S7 of the tubular portion 23. At this time, the second lip portion 52 is deformed such that the gap G2 becomes smaller and an angle formed by the first inclined portion 521 and the second inclined portion 522 becomes smaller.

When further rotating the cover 4, as shown in FIG. 7, the cover 4 moves to the closed position where the tip end of the first lip portion 51 comes into contact with an end surface S6 of the tubular portion 23, and a space between the cover 4 and the tubular portion 23 is sealed by the packing 5. More specifically, the end surface S6 of the tubular portion 23 includes an inclined surface S61 that is continuous with the inner surface S5 of the tubular portion 23 and has a slope that approaches an outer surface S7 of the tubular portion 23 as the slope goes forward, and an orthogonal surface S62 that is continuous with the inclined surface S61 and is orthogonal to the front-back direction. The first lip portion 51 comes into contact with the inclined surface S5 of the end surface S6.

When fitting to the inlet plug, the motor 6 rotates the cover 4 to the open position. Accordingly, the front opening 21 is open, and the inlet plug can be inserted into the tubular portion 23.

According to the embodiment described above, the outer surface of the packing 5 includes the first lip portion 51 that comes into contact with the end surface S6 of the tubular portion 23 and covers the end surface S6 from a front side, and the second lip portion 52 that is provided behind the first lip portion 51 and press-fitted between the cover 4 and the inner surface S5 of the tubular portion 23, at the closed position. In this way, since a double structure with the two lip portions 51, 52 is formed, waterproofness and dustproof property can be improved. The first lip portion 51 comes into contact with the end surface S6 of the tubular portion 23 at the closed position, and is not inserted rearward until the first lip portion 51 comes into sliding-contact with the inner surface S5 of the tubular portion 23 as the second lip portion 52. Therefore, even if the two lip portions 51, 52 are provided, an insertion force applied when closing the cover 4 can be reduced.

According to the embodiment described above, the first lip portion 51 is provided such that the tip end thereof comes into contact with the end surface S6 of the tubular portion 23 at the closed position. Accordingly, there is no gap between the first lip portion 51 and the tubular portion 23, and the waterproofness and dustproof property can be further improved.

According to the embodiment described above, the first lip portion 51 comes into contact with the inclined surface S61. Accordingly, the first lip portion 51 can also be press-fitted, and the waterproofness and dustproof property can be further improved.

According to the embodiment described above, the first lip portion 51 and the second lip portion 52 have shapes approaching each other toward the tip ends. Accordingly, the tip end of the second lip portion 52 can have a shape that is less likely to be caught when the second lip portion 52 is in sliding-contact with the inner surface S5 of the tubular portion 23, and the insertion force can be further reduced. Further, the tip end of the first lip portion 51 can have a shape that is easily caught on the end surface S6 of the tubular portion 23.

According to the embodiment described above, the packing 5 has the first recess 53 formed in the surface on the one side in the central axis direction of the annular shape (front side in FIG. 3), and the second recess 54 formed in the surface on the other side in the central axis direction (rear side in FIG. 3). The cover 4 to which the packing 5 is to be attached includes the front cover 41 and the rear cover 42 that are separately provided to sandwich and hold the packing 5 therebetween. The front cover 41 includes the first protrusion 413 to be inserted into and held by the first recess 53, and the rear cover 42 includes the second protrusion 422 to be inserted into and held by the second recess 54. Accordingly, the packing 5 is sandwiched and firmly held between the front cover 41 and the rear cover 42. Therefore, when rotating the cover 4 to the closed position, even if the packing 5 is in sliding-contact with the inner surface of the tubular portion 23, it is possible to prevent an assembly failure of the packing 5 such as biting or coming-off of the packing 5.

According to the embodiment described above, the side surfaces S1, S2 of the first protrusion 413 and the second protrusion 422 are provided on the first inclined surfaces that are away from the contact surfaces (tip ends of the first lip portion 51 and the second lip portion 52) as approaching each other. The side surfaces S3, S4, facing the side surfaces S1, S2 of the first protrusion 413 and the second protrusion 422, of the first recess 53 and the second recess 54 are provided on the second inclined surfaces that are away from the contact surfaces (tip ends of the first lip portion 51 and the second lip portion 52) as approaching each other. The first lip portion 51 and the second lip portion 52 include the first inclined portions 511, 521 that are inclined along the second inclined surfaces, and the second inclined portions 512, 522 that are continuous with tip ends of the first inclined portions 511, 521 and approach each other toward the tip ends.

Accordingly, the tip end of the second lip portion 52 can have a shape that is less likely to be caught when the second lip portion 52 is in sliding-contact with the inner surface S5 of the tubular portion 23, and the insertion force can be further reduced. Further, the tip end of the first lip portion 51 can have a shape that is easily caught on the end surface S6 of the tubular portion 23. When the cover 4 is at the closed position, even if water or dust enters beyond the first lip portion 51, the water or dust is returned toward the first lip portion 51 along the first inclined portion 521 and the second inclined portion 522 of the second lip portion 52, and thus the waterproofness and dustproof property can be further improved.

The present invention is not limited to the embodiment described above, and can be appropriately modified, improved, or the like. In addition, materials, shapes, sizes, numbers, arrangement positions and the like of components in the embodiment described above are freely selected and are not limited as long as the present invention can be implemented.

The first lip portion 51 is provided such that the tip end thereof comes into contact with the end surface S6 of the tubular portion 23 at the closed position according to the embodiment described above, but the present invention is not limited thereto. The first lip portion 51 may cover at least a part of the end surface S6 from the front side, and may not come into contact with the end surface S6.

The first lip portion 51 is provided such that the tip end thereof comes into contact with the inclined surface S61 of the end surface S6 of the tubular portion 23 at the closed position according to the embodiment described above, but the present invention is not limited thereto. The first lip portion 51 may be provided such that the tip end thereof comes into contact with the orthogonal surface S62 at the closed position.

The first lip portion 51 and the second lip portion 52 include the first inclined portions 511, 521 and the second inclined portions 512, 522 according to the embodiment described above, but the present invention is not limited thereto. The first lip portion 51 and the second lip portion 52 may simply protrude toward the inner surface of the tubular portion 23.

The packing 5 is sandwiched and held between the front cover 41 and the rear cover 42 according to the embodiment described above, but the present invention is not limited thereto. The cover 4 may include one component, and the packing 5 may be held by the cover 4 by being fitted into a groove formed in the cover 4.

Here, features of the connector according to the embodiment of the present invention described above are briefly summarized and listed in the following [1] to [4].

[1] A connector (1) includes:
a housing (2) including an accommodating portion (22) that accommodates a connection terminal and a tubular portion (23) having an opening (21) into which a mating connector is to be inserted;
a cover (4) configured to cover the opening (21) in an openable and closable manner; and
an annular packing (5) configured to be attached to the cover (4) and to seal a gap between the tubular portion (23) and the cover (4) at a closed position where the cover (4) closes the opening (21), in which
an outer surface of the packing (5) includes a first lip portion (51) that covers an end surface (S6) of the tubular portion (23) from a side in a direction opposite to (front side) an insertion direction of the mating connector, and a second lip portion (52) provided on the insertion direction side of (behind) the first lip portion (51) and press-fitted between the cover (4) and an inner surface (S5) of the tubular portion (23), at the closed position.

According to a configuration of [1], since a double structure with the two lip portions (51), (52) is formed, waterproofness and dustproof property can be improved. The first lip portion (51) comes into contact with the end surface (S6) of the tubular portion (23) at the closed position, and is not inserted rearward until the first lip portion (51) comes into sliding-contact with the inner surface (S5) of the tubular portion (23) as the second lip portion (52). Therefore, even if the two lip portions (51), (52) are provided, an insertion force applied when closing the cover (4) can be reduced.

[2] In the connector (1) according to [1],
the first lip portion (51) is provided such that a tip end thereof comes into contact with the end surface (S6) of the tubular portion (23) at the closed position.

According to a configuration of [2], there is no gap between the first lip portion (51) and the tubular portion (23), and the waterproofness and the dustproof property can be further improved.

[3] In the connector (1) according to [2],
the end surface (S6) of the tubular portion (23) includes an inclined surface (S61) that is continuous with the inner surface (S5) of the tubular portion (23) and has a slope that approaches an outer surface (S7) of the tubular portion (23) as the slope goes in the opposite direction (forward), and an orthogonal surface (S62) that is continuous with the inclined surface (S61) and is orthogonal to the insertion direction, and
the first lip portion (51) is provided such that the tip end thereof comes into contact with the inclined surface (S61) at the closed position.

According to a configuration of [3], the first lip portion (51) can also be press-fitted, and the waterproofness and dustproof property can be further improved.

[4] In the connector (1) according to any one of [1] to [3],
the first lip portion (51) and the second lip portion (52) have shapes approaching each other toward tip ends.

According to a configuration of [4], the tip end of the second lip portion (52) can have a shape that is less likely to be caught when the second lip portion (52) is in sliding-contact with the inner surface (S5) of the tubular portion (23), and the insertion force can be further reduced. Further, the tip end of the first lip portion (51) can have a shape that is easily caught on the end surface (S6) of the tubular portion (23).

[5] In the connector (1) according to any one of [1] to [4],
the packing (5) has a first recess (53) formed in a surface on one side in a central axis direction of a annular shape (front side) and a second recess (54) formed in a surface on the other side in the central axis direction (rear side),
the cover (4) includes a first member (41) and a second member (42) that are separately provided to sandwich and hold the packing (5) therebetween,
the first member (41) includes the first protrusion (413) to be inserted into and held by the first recess (53), and
the second member (42) includes the second protrusion (422) to be inserted into and held by the second recess (54).

According to a configuration of [5], the packing (5) is sandwiched and firmly held between the first member (41) and the second member (42). Therefore, when moving the cover (4) to the closed position, even if the packing (5) is in sliding-contact with the housing (2), it is possible to prevent an assembly failure of the packing (5) such as biting or coming-off of the packing (5).

[6] In the connector (1) according to [5],
side surfaces (S1, S2) of the first protrusion (413) and the second protrusion (422) close to the first lip portion (51) and the second lip portion (52) are respectively provided on first inclined surfaces that are away from tip ends of the first lip portion (51) and the second lip portion (52) as approaching each other,
surfaces (S3, S4), facing the side surfaces (S1, S2) of the first protrusion (413) and the second protrusion (422), of the first recess (53) and the second recess (54) are respectively provided on second inclined surfaces that are away from the tip ends of the first lip portion (51) and the second lip portion (52) as approaching each other, and
the first lip portion (51) and the second lip portion (52) include first inclined portions (511, 521) that are inclined along the second inclined surfaces, and second inclined portions (512, 522) that are continuous with tip ends of the first inclined portions (511, 521) and approach each other toward the tip ends.

According to a configuration of [6], the tip end of the second lip portion (52) can have a shape that is less likely to be caught when the second lip portion (52) is in sliding-contact with the inner surface (S5) of the tubular portion (23), and the insertion force can be further reduced. Further, the tip end of the first lip portion (51) can have a shape that is easily caught on the end surface (S6) of the tubular portion (23). When the cover (4) is at the closed position, even if water or dust enters beyond the first lip portion (51), the water or dust is returned toward the first lip portion (51) along the first inclined portion (521) and the second inclined portion (522) of the second lip portion (52), and thus the waterproofness and dustproof property can be further improved.

Although the present invention has been described in detail with reference to the specific embodiments, it is apparent to those skilled in the art that various changes and modifications can be made without departing from the spirit and scope of the present invention.

The present application is based on a Japanese patent application (Japanese Patent Application No. 2022-025077) filed on Feb. 21, 2022, contents of which are incorporated herein by reference.

### INDUSTRIAL APPLICABILITY

According to the present invention, it is possible to provide a connector that improves waterproofness and dustproof property while reducing a force applied when closing a cover. The present invention having this effect is useful for connectors.

### REFERENCE SIGNS LIST

1: inlet (connector)
2: housing
4: cover
5: packing
21: front opening (opening)
22: accommodating portion
23: tubular portion
41: front cover (first member)
42: rear cover (second member)
51: first lip portion
52: second lip portion
53: first recess
54: second recess
413: first protrusion
422: second protrusion
511, 521: first inclined portion
512, 522: second inclined portion
S1, S2: side surface
S3, S4: side surface (surface)
S5: inner surface
S6: end surface
S7: outer surface
S61: inclined surface
S62: orthogonal surface

1. A connector comprising:
a housing including an accommodating portion that accommodates a connection terminal and a tubular portion having an opening into which a mating connector is to be inserted;
a cover configured to cover the opening in an openable and closable manner; and
an annular packing configured to be attached to the cover and to seal a gap between the tubular portion and the cover at a closed position where the cover closes the opening, wherein
an outer surface of the packing includes a first lip portion that covers an end surface of the tubular portion from a side in a direction opposite to an insertion direction of the mating connector, and a second lip portion provided on an insertion direction side of the first lip portion and press-fitted between the cover and an inner surface of the tubular portion, at the closed position.

2. The connector according to claim 1, wherein
the first lip portion is provided such that a tip end thereof comes into contact with the end surface of the tubular portion at the closed position.

3. The connector according to claim 2, wherein:
the end surface of the tubular portion includes an inclined surface that is continuous with the inner surface of the tubular portion and has a slope that approaches an outer surface of the tubular portion as the slopes goes in the opposite direction, and an orthogonal surface that is continuous with the inclined surface and is orthogonal to the insertion direction; and
the first lip portion is provided such that the tip end thereof comes into contact with the inclined surface at the closed position.

4. The connector according to claim 1, wherein
the first lip portion and the second lip portion have shapes approaching each other toward tip ends.

5. The connector according to claim 1, wherein:
the packing has a first recess formed in a surface on one side in a central axis direction of a annular shape and a second recess formed in a surface on the other side in the central axis direction;
the cover includes a first member and a second member that are separately provided to sandwich and hold the packing therebetween;
the first member includes the first protrusion to be inserted into and held by the first recess; and
the second member includes the second protrusion to be inserted into and held by the second recess.

6. The connector according to claim 5, wherein:
side surfaces of the first protrusion and the second protrusion close to the first lip portion and the second lip portion are respectively provided on first inclined surfaces that are away from tip ends of the first lip portion and the second lip portion as approaching each other;
surfaces, facing the side surfaces of the first protrusion and the second protrusion, of the first recess and the second recess are respectively provided on second inclined surfaces that are away from the tip ends of the first lip portion and the second lip portion as approaching each other; and
the first lip portion and the second lip portion include first inclined portions that are inclined along the second inclined surfaces, and second inclined portions that are continuous with tip ends of the first inclined portions and approach each other toward the tip ends.
